(19) United States
(12) Patent Application Publication
(10) Pub. No.: US 2010/0282534 A1
(43) Pub. Date: Nov. 11, 2010

(54) Motorized Bicycle with Electric Generating Function

(76) Inventor: Wei-Ting Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/436,915

(22) Filed: May 7, 2009

(51) Int. Cl. B62M 23/02; B62M 1/10

(52) U.S. Cl. 180/205; 280/215

(57) ABSTRACT

A motorized bicycle includes a bicycle body, a rotation device, a chargeable battery and a control device. The rotation device includes a mandrel, a plurality of coils, a rotation member and a plurality of magnets. The control device includes a microprocessor and an adjusting switch. When the rotation device is disposed at the active state, the rotation device is driven by the electric power of the battery to move the bicycle forward, and when the rotation device is disposed at the passive state, the pedals are pedalled by the rider to rotate the front wheel, and the rotation device is driven by the front wheel to provide a generating function. The microprocessor can switch the active state and the passive state of the rotation device automatically to operate the electric power of the battery to the optimum extent.

### BACKGROUND OF THE INVENTION

1. Field of the Invention

The present invention relates to a bicycle and, more particularly, to a motorized bicycle.

2. Description of the Related Art

A conventional motorized bicycle in accordance with the prior art shown in FIG. 5 comprises a frame 51, a front wheel 50 a motor 60 and a storage battery 70. The motor 60 has an output gear 61 meshing with a serrated wheel rim 55 of the front wheel 50. The storage battery 70 is electrically connected to the motor 60. In operation, the storage battery 70 supplies an electric power to the motor 60 which drives the output gear 61 which drives the wheel rim 55 which drives the front wheel 50 so as to move the bicycle forward. Thus, the bicycle is moved forward by the electric power of the storage battery 70 so as to save a rider's energy. However, the electric power supplied by the storage battery 70 is not large enough so that the electricity of the storage battery 70 is easily consumed and exhausted during a longer period of time, thereby limiting movement of the bicycle.

### BRIEF SUMMARY OF THE INVENTION

In accordance with the present invention, there is provided a motorized bicycle, comprising a bicycle body, a rotation device mounted on the bicycle body and including a mandrel, a plurality of coils mounted on the mandrel, a rotation member rotatably mounted on the mandrel and surrounding the coils, and a plurality of magnets mounted in the rotation member to move in concert with the rotation member and movable to pass the coils, a chargeable battery mounted on the bicycle body and electrically connected to each of the coils of the rotation device to supply an electric power to each of the coils of the rotation device, and a control device mounted on the bicycle body and including a microprocessor electrically connected to the battery and each of the coils of the rotation device to regulate the electric power from the battery to each of the coils of the rotation device, and an adjusting switch connected to the microprocessor to control operation of the microprocessor.

The primary objective of the present invention is to provide a motorized bicycle with an electric generating function.

Another objective of the present invention is to provide a motorized bicycle that is changeable between a motor and a generator.

A further objective of the present invention is to provide a motorized bicycle, wherein when the rotation device is disposed at the active state, the rotation device is driven by the electric power of the battery so as to move the bicycle forward, and when the rotation device is disposed at the passive state, the pedals are pedalled by the rider to rotate the front wheel, and the rotation device is driven by the front wheel so as to provide a generating function.

A further objective of the present invention is to provide a motorized bicycle, wherein the microprocessor can switch the active state and the passive state of the rotation device automatically so as to operate the electric power of the battery to the optimum extent.

A further objective of the present invention is to provide a motorized bicycle, wherein when the front wheel is braked, the speed of the front wheel is reduced gradually to prevent the front wheel from being locked or jammed instantaneously and to prevent the bicycle from slipping during an accidental braking process so as to protect the rider's safety.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a side view of a motorized bicycle in accordance with the preferred embodiment of the present invention.

FIG. 2 is a side cross-sectional view of a rotation device of the motorized bicycle as shown in FIG. 1.

FIG. 3 is a front cross-sectional view of the rotation device of the motorized bicycle as shown in FIG. 2.

FIG. 4 is a block diagram of the motorized bicycle as shown in FIG. 1.

FIG. 5 is a partially perspective view of a conventional motorized bicycle in accordance with the prior art.

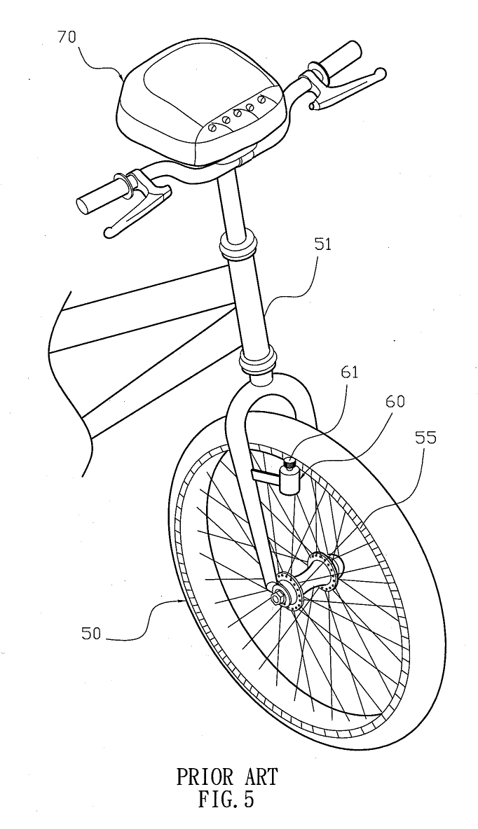

### DETAILED DESCRIPTION OF THE INVENTION

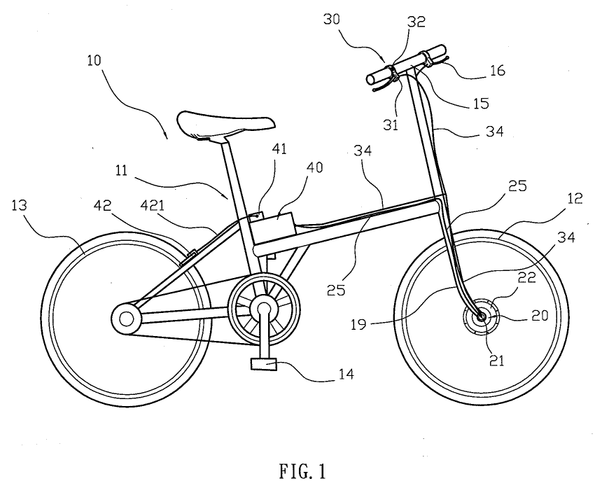

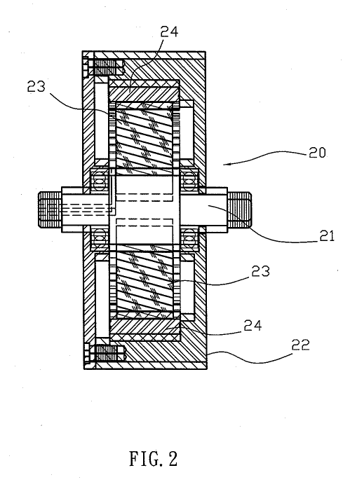

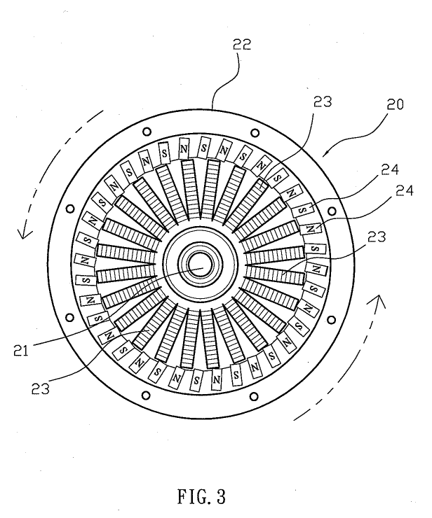

Referring to the drawings and initially to FIGS. 1-3, a motorized bicycle in accordance with the preferred embodiment of the present invention comprises a bicycle body 10, a rotation device 20 mounted on the bicycle body 10 and including a mandrel 21, a plurality of coils 23 mounted on the mandrel 21, a rotation member 22 rotatably mounted on the mandrel 21 and surrounding the coils 23, and a plurality of magnets 24 mounted in the rotation member 22 to move in concert with the rotation member 22 and movable to pass the coils 23, a chargeable battery 40 mounted on the bicycle body 10 and electrically connected to each of the coils 23 of the rotation device 20 to supply an electric power to each of the coils 23 of the rotation device 20, and a control device 30 mounted on the bicycle body 10 and including a microprocessor 31 electrically connected to the battery 40 and each of the coils 23 of the rotation device 20 to regulate the electric power from the battery 40 to each of the coils 23 of the rotation device 20, and an adjusting switch 32 connected to the microprocessor 31 to control operation of the microprocessor 31.

The bicycle body 10 includes a frame 11, a front wheel 12, a rear wheel 13, two pedals 14, a handlebar 15, two brake levers 16, and a front fork 19.

The rotation device 20 further includes an electric wire 25 electrically connected between each of the coils 23 and the battery 40 to deliver the electric power from the battery 40 to each of the coils 23. The mandrel 21 of the rotation device 20 is mounted on a lower end of the front fork 19 of the bicycle body 10. The rotation member 22 of the rotation device 20 is centered at the mandrel 21 and is mounted on a central portion of the front wheel 12 of the bicycle body 10 to move in concert with the front wheel 12 of the bicycle body 10. The coils 23 of the rotation device 20 are arranged in a radiating manner. Each of the coils 23 of the rotation device 20 is directed in a radial direction that extends radially and outwardly from the mandrel 21.

The control device 30 is mounted on the handlebar 15 of the bicycle body 10. The microprocessor 31 of the control device 30 is connected to the handlebar 15 and the brake levers 16 of the bicycle body 10. The microprocessor 31 of the control device 30 is provided with a signal line 34 connected to the coils 23 of the rotation device 20 and the battery 40. The adjusting switch 32 of the control device 30 is switched between a normal mode, an exercising mode and a climbing mode.

The battery 40 is mounted on the frame 11 of the bicycle body 10 and is provided with a receiver 41. The motorized bicycle further comprises a coder 42 mounted on the bicycle body 10 and a coding wire 421 electrically connected between the coder 42 and the receiver 41 of the battery 40. The coder 42 is mounted on the frame 11 of the bicycle body 10 and is in alignment with the rear wheel 13 of the bicycle body 10 to transmit a velocity signal of the rear wheel 13 of the bicycle body 10 through the coding wire 421 to the receiver 41 of the battery 40.

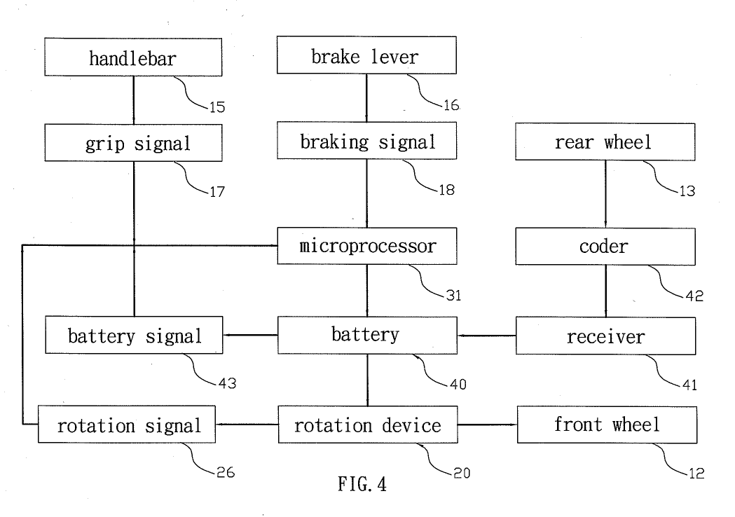

As shown in FIG. 4, the rotation device 20 is connected to the front wheel 12 and can send a rotation signal 26 (indicating the rotation velocity of the rotation device 20 and the front wheel 12) to the microprocessor 31. In addition, the battery 40 is connected to the rear wheel 13 via the receiver 41 and the coder 42 and can send a battery signal 43 (indicating the electric power of the battery 40) to the microprocessor 31. In addition, the handlebar 15 functions as a twist grip throttle and can send a grip signal 17 to the microprocessor 31. In addition, each of the brake levers 16 can send a braking signal 18 to the microprocessor 31.

In operation, referring to FIGS. 1-4, the rotation device 20 is operable between an active state and a passive state. When the rotation device 20 is disposed at the active state, the electric current from the battery 40 is delivered through the electric wire 25 to each of the coils 23, so that each of the coils 23 produces a magnetic field, and the magnetic lines of each of the coils 23 is directed in a radial direction that extends radially and outwardly from the mandrel 21. At this time, any two adjacent coils 23 have different current directions, so that any two adjacent coils 23 have different magnetic poles. That is, when one of the coils 23 has a north (N) pole, an adjacent coil 23 has a south (S) pole, so that the north (N) poles and the south (S) poles of the coils 23 are arranged in a staggered manner. In such a manner, when one magnet 24 having a north (N) pole aligns with a respective coil 23 having a north (N) pole, the magnet 24 having a north (N) pole is repelled by the respective coil 23 having a north (N) pole and is attracted by an adjacent coil 23 having a south (S) pole, so that the magnet 24 having a north (N) pole is moved forward by action of the two coils 23. Then, when the magnet 24 having a north (N) pole aligns with a respective coil 23 having a south (S) pole, the current direction of each of the coils 23 is reversed instantaneously to change the magnetic pole of each of the coils 23, so that the respective coil 23 is changed to have a north (N) pole, and an adjacent coil 23 is changed to have a south (S) pole. Thus, the magnet 24 having a north (N) pole is repelled by the respective coil 23 having a north (N) pole and is attracted by an adjacent coil 23 having a south (S) pole, so that the magnet 24 having a north (N) pole is moved forward again by action of the two coils 23. Therefore, the magnetic pole of each of the coils 23 is changed successively to move each of the magnets 24 successively so that the rotation member 22 is driven by the magnets 24 to rotate relative to the mandrel 21 so as to rotate the front wheel 12 and to move the bicycle body 10 forward. On the contrary, when the rotation device 20 is disposed at the passive state, the electric current from the battery 40 to each of the coils 23 is stopped, and the pedals 14 are pedalled by a rider. In such a manner, the rotation member 22 is driven by the front wheel 12 to rotate relative to the mandrel 21, so that the magnets 24 are rotated relative to the coils 23 to produce a magnetic interaction between the magnets 24 and the coils 23 so as to produce an electric current which is delivered through the electric wire 25 to the battery 40.

Thus, when the rotation device 20 is disposed at the active state, the rotation device 20 is driven by the electric power of the battery 40 so as to move the bicycle forward, and when the rotation device 20 is disposed at the passive state, the pedals 14 are pedalled by the rider to rotate the front wheel 12, and the rotation device 20 is driven by the front wheel 12 so as to provide a generating function. In addition, the microprocessor 31 can control the active state and the passive state of the rotation device 20 so that the rider can select the active state and the passive state of the rotation device 20. In addition, when the bicycle is traveled on a downward slope, the microprocessor 31 switches operation of the rotation device 20 automatically according to the rotation signal 26 (indicating the rotation velocity of the rotation device 20 and the front wheel 12) of the rotation device 20, so that the rotation device 20 is controlled by the microprocessor 31 to change from the active state (the rotation device 20 is driven by the battery 40) to the passive state (the rotation device 20 is driven by the front wheel 12) to save the electric power of the battery 40.

On the other hand, the adjusting switch 32 of the control device 30 is switched by the rider between a normal mode, an exercising mode and a climbing mode. When the rider switches the adjusting switch 32 of the control device 30 to the normal mode, the rotation device 20 is disposed at the active state, and the battery 40 supplies an electric current to each of the coils 23, so that the rotation device 20 is driven by the electric power of the battery 40 so as to move the bicycle forward. At this time, the handlebar 15 functions as a twist grip throttle to control the rotation speed of the rotation device 20 so as to control the rotation speed of the front wheel 12. When the rider switches the adjusting switch 32 of the control device 30 to the exercising mode, the rotation device 20 is disposed at the passive state, and the electric current from the battery 40 to each of the coils 23 is stopped, so that the pedals 14 are pedalled by the rider to rotate the front wheel 12 to achieve an exercising effect, and the rotation device 20 is driven by the front wheel 12 so as to provide a generating function. When the rider switches the adjusting switch 32 of the control device 30 to the climbing mode, the rotation device 20 is disposed at the active state and the passive state. At this time, the front wheel 12 is partially driven by the electric power of the battery 40 and partially driven by the rider's pedalling so that the rider can ride the bicycle to climb an upward slope in energy-saving manner by aid of the electric power of the battery 40.

On the other hand, when the brake levers 16 are pressed by the rider during a forward movement of the bicycle, each of the brake levers 16 can send a braking signal 18 to the microprocessor 31. Then, the microprocessor 31 controls the battery 40 to supply an electric current to each of the coils 23 so that each of the coils 23 produces a magnetic field. At this time, each of the coils 23 is controlled by the microprocessor 31 to have a magnetic pole that is the same as that of the respective magnet 24 to produce a repulsive force to the respective magnet 24 so as to damp movement of the respective magnet 24 and to stop movement of the rotation member 22 so as to stop movement of the front wheel 12 and to brake the bicycle. In practice, when one magnet 24 having a north (N) pole aligns with a respective coil 23, the respective coil 23 is controlled by the microprocessor 31 to have a north (N) pole to repel and damp movement of the magnet 24 having a north (N) pole, and when one magnet 24 having a south (S) pole aligns with a respective coil 23, the respective coil 23 is controlled by the microprocessor 31 to have a south (S) pole to repel and damp movement of the magnet 24 have a south (S) pole. In such a manner, the magnets 24 are repelled and damped successively by the repulsive actions of the coils 23 during rotation of the front wheel 12 to stop movement of the rotation member 22 gradually so as to stop movement of the front wheel 12 and to brake the bicycle gradually.

At the same time, the coder 42 transmits a velocity signal of the rear wheel 13 to the receiver 41 of the battery 40, and the microprocessor 31 can reduce the velocity of the front wheel 12 to be equal to that of the rear wheel 13 according to velocity signal from the coder 42. Thus, the front wheel 12 and the rear wheel 13 have the same velocity by control of the microprocessor 31 so that when the front wheel 12 is braked, the speed of the front wheel 12 is reduced gradually to prevent the front wheel 12 from being locked or jammed instantaneously and to prevent the bicycle from slipping during an accidental braking process so as to protect the rider's safety.

Accordingly, when the rotation device 20 is disposed at the active state, the rotation device 20 is driven by the electric power of the battery 40 so as to move the bicycle forward, and when the rotation device 20 is disposed at the passive state, the pedals 14 are pedalled by the rider to rotate the front wheel 12, and the rotation device 20 is driven by the front wheel 12 so as to provide a generating function. In addition, the microprocessor 31 can switch the active state and the passive state of the rotation device 20 automatically so as to operate the electric power of the battery 40 to the optimum extent. Further, when the front wheel 12 is braked, the speed of the front wheel 12 is reduced gradually to prevent the front wheel 12 from being locked or jammed instantaneously and to prevent the bicycle from slipping during an accidental braking process so as to protect the rider's safety.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A motorized bicycle, comprising:
a bicycle body;
a rotation device mounted on the bicycle body and including a mandrel, a plurality of coils mounted on the mandrel, a rotation member rotatably mounted on the mandrel and surrounding the coils, and a plurality of magnets mounted in the rotation member to move in concert with the rotation member and movable to pass the coils;
a chargeable battery mounted on the bicycle body and electrically connected to each of the coils of the rotation device to supply an electric power to each of the coils of the rotation device;
a control device mounted on the bicycle body and including a microprocessor electrically connected to the battery and each of the coils of the rotation device to regulate the electric power from the battery to each of the coils of the rotation device, and an adjusting switch connected to the microprocessor to control operation of the microprocessor.

2. The motorized bicycle of claim 1, wherein the rotation device further includes an electric wire electrically connected between each of the coils and the battery to deliver the electric power from the battery to each of the coils.

3. The motorized bicycle of claim 1, wherein
the bicycle body includes a frame, a front wheel, a rear wheel, two pedals, a handlebar, two brake levers, and a front fork;
the mandrel of the rotation device is mounted on a lower end of the front fork of the bicycle body;
the rotation member of the rotation device is mounted on a central portion of the front wheel of the bicycle body to move in concert with the front wheel of the bicycle body.

4. The motorized bicycle of claim 1, wherein
the bicycle body includes a frame, a front wheel, a rear wheel, two pedals, a handlebar, two brake levers, and a front fork;
the control device is mounted on the handlebar of the bicycle body.

5. The motorized bicycle of claim 4, wherein the microprocessor of the control device is connected to the handlebar and the brake levers of the bicycle body.

6. The motorized bicycle of claim 2, wherein the microprocessor of the control device is provided with a signal line connected to the coils of the rotation device and the battery.

7. The motorized bicycle of claim 1, wherein
the bicycle body includes a frame, a front wheel, a rear wheel, two pedals, a handlebar, two brake levers, and a front fork;
the battery is mounted on the frame of the bicycle body.

8. The motorized bicycle of claim 1, wherein
the battery is provided with a receiver;
the motorized bicycle further comprises:
a coder mounted on the bicycle body;
a coding wire electrically connected between the coder and the receiver of the battery.

9. The motorized bicycle of claim 8, wherein
the bicycle body includes a frame, a front wheel, a rear wheel, two pedals, a handlebar, two brake levers, and a front fork;
the coder is mounted on the frame of the bicycle body and is in alignment with the rear wheel of the bicycle body to transmit a velocity signal of the rear wheel of the bicycle body through the coding wire to the receiver of the battery.

10. The motorized bicycle of claim 1, wherein the adjusting switch of the control device is switched between a normal mode, an exercising mode and a climbing mode.

11. The motorized bicycle of claim 5, wherein the handlebar functions as a twist grip throttle and sends a grip signal to the microprocessor.

12. The motorized bicycle of claim 3, wherein
when the rotation device is disposed at an active state, the rotation device is driven by the electric power of the battery so as to move the bicycle forward;
when the rotation device is disposed at a passive state, the pedals are pedalled by the rider to rotate the front wheel, and the rotation device is driven by the front wheel so as to provide a generating function.

13. The motorized bicycle of claim 12, wherein the microprocessor controls the active state and the passive state of the rotation device.

14. The motorized bicycle of claim 1, wherein
the coils of the rotation device are arranged in a radiating manner;
each of the coils of the rotation device is directed in a radial direction that extends radially and outwardly from the mandrel.

15. The motorized bicycle of claim 1, wherein the rotation member of the rotation device is centered at the mandrel.
